(19) United States
(12) Patent Application Publication
(10) Pub. No.: US 2008/0212933 A1
(43) Pub. Date: Sep. 4, 2008

(54) Multi-Zonal Video Editing System

(75) Inventor: Alec Cawley, Newbury (GB)

Correspondence Address: GARRETT IP, LLC, 3060 GEORGIA AVE (RT. 97), SUITE 270, GLENWOOD, MD, 21738-9738, US

(73) Assignee: Quantel Limited, Berkshire (GB)

(21) Appl. No.: 11/815,299

(22) PCT Filed: Feb. 1, 2006
(86) PCT No.: PCT/GB06/00326

§ 371 Date: Aug. 1, 2007

(30) Foreign Application Priority Data
Feb. 4, 2005 (GB) 0502332.0

(51) Int. Cl. G11B 27/00; G06F 17/30

(52) U.S. Cl. 386/52; 707/10; 707/7; 386/E05.028; 707/E17.032

(57) ABSTRACT

The invention provides a network-based video editing system, in which video clips are made available on demand to servers located in a plurality of spatially separated zones linked only via the network. In order to ensure that cautionary or advisory information contained in signs or signals (“tags”) associated with certain video material is retained during transfer between servers in different zones, the invention provides that new tags associated with video material in any zone are broadcast generally to all other zones. Only tags associated with video information currently stored in any zone are retained in that zone, but all tags associated with information copied from a first zone to a second zone are supplied to the second zone. In a preferred system, the video material is time-stamped to permit conflicts in the content of multiple tags relating to the same video material to be resolved by making the most recent prevail. The invention also provides a method for operating such a system.

The present invention relates to multi-zonal video editing systems; that is to say network-based video editing systems in which video clips are made available on demand to servers located in a plurality of spatially separated zones linked only (so far as video clip materials are concerned) via the network. In such systems, the clips may typically be derived from so-called “rushes”, which comprise strings of frames of video data. Typically, each rush is allocated a unique identity and the various video frames of a rush all bear this identity plus a sequentially issued frame number. Thus, each video frame can be uniquely identified.

When video information existing on a server in a first zone needs to be copied on demand to a server in a second zone, it is preferred that the system management utilises the individual frame identities to ensure that any frames of the demanded video already stored in the server in the second zone are not copied, since any frames already stored in the second zone server can be inserted into their appropriate places in the remainder of the rush when it has been copied across. This arrangement is well known, and makes efficient use of bandwidth on the network connection between the zones, as well as preserving local (zonally-based) server storage.

However, the video information comprised in certain frames, combinations of frames or entire rushes may have associated therewith cautionary or advisory information conveyed in one or more signals or signs (commonly called “tags”). Such information may, for example, include such things as copyright attributions, broadcast time/date embargos, parental guidance indicators and watershed timing advice in relation to the associated video information. Difficulties arise, however, in reliably ensuring that video information copied from a first zone to a second zone is not broadcast from the second zone in ignorance of the information carried by any tags relating to such video information. A particular difficulty in this respect arises in relation to the maintenance of current information about tags in the various zones.

It is an object of this invention to reduce or eliminate such difficulties.

The invention also encompasses a method for operating such a system as aforesaid.

According to the present invention from one aspect, there is provided a network-based video editing system in which video material, all frames of which bear unique identifiers, is made available on demand to servers located in a plurality of spatially separated zones linked via the network and wherein certain of the video material has associated therewith one or more signals or signs (hereinafter called “tags”), indicative of cautionary or advisory information; each zone of the system comprising:

(a) notification means for providing notifications to the other zone or zones of tags as they are received;
(b) management means for receiving such notifications from the other zone or zones, for deriving from such notifications one or more frame identifiers relating to the video material associated with notified tags, comparing the frame identifiers so derived with those relating to video material stored in the zone, retaining any said tag which relates to such stored video material, for associating respective retained tags with the appropriate stored video material, and for rejecting other tags; and
(c) further means for transmitting to any other zone all tags associated with video information copied to said other zone.

By this means, new tags associated with material in any zone are broadcast generally to all other zones; only tags associated with video information stored in any zone are retained in that zone. Moreover, all tags associated with information copied from a first zone to a second zone are supplied to the second zone as it is likely that, due to the preceding operation, the management means at the second zone will not have retained such tags.

In a preferred system, the video information is time-stamped in order to permit any conflicts in the content of multiple tags relating to the same video material to be resolved by making the most recent prevail.

It is further preferred that the system comprises means for periodically purging each zone of tags which apply to video information no longer stored in that zone. This can be implemented by means of a background purger running at pre-selected intervals. If this is done, the management associated with new tag storage can be changed such that all tags are stored in all zones as received; those tags not associated with the video information in any given zone being purged at the next operation of the background purger for that zone.

According to the invention from another aspect there is provided a method of operating a network-based video editing system in which video material, all frames of which bear unique identifiers, is made available on demand to servers located in a plurality of spatially separated zones linked via the network and wherein certain of the video material has associated therewith one or more signals or signs (hereinafter called “tags”), indicative of cautionary or advisory information, wherein (a) new tags associated with material in any zone are broadcast generally to all other zones; (b) only tags associated with video information stored in any zone are retained in that zone and (c) all tags associated with information copied from a first zone to a second zone are supplied to the second zone.

Preferably, the method includes the further step of time-stamping the video information whereby any conflicts in the content of multiple tags relating to the same video material can be resolved by making the most recent prevail.

It is further preferred that the method comprises the further step of periodically purging each zone of tags which apply to video information not stored in that zone.

In order that the invention may be clearly understood and readily carried into effect, one embodiment thereof will now be described (by way of example only) with reference to the accompanying drawings, of which:

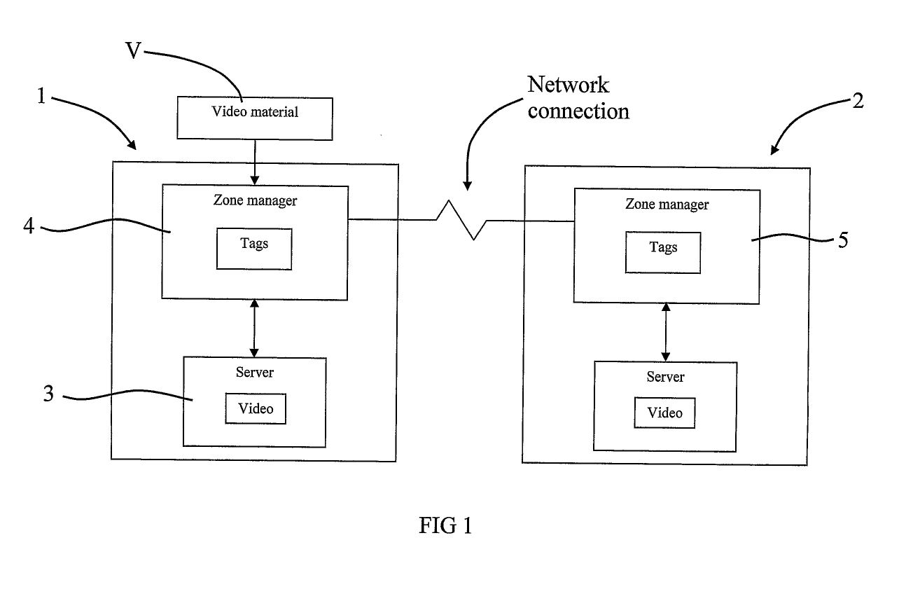

FIG. 1 shows, a schematic outline diagram of a system in accordance with one example of the invention; and

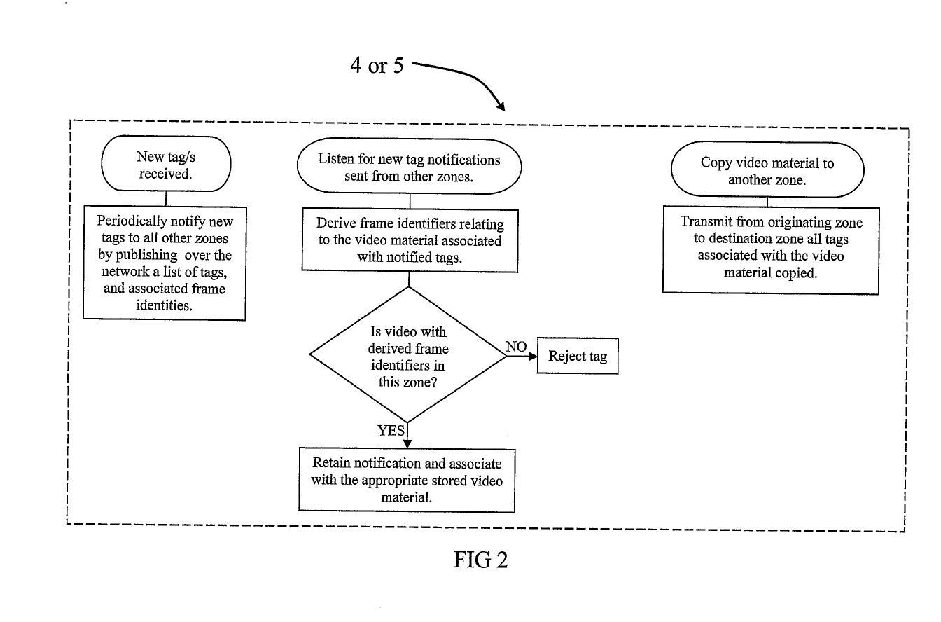

FIG. 2 shows schematically and in flow diagrammatic form certain functions performed by zone managers incorporated in a system of the kind shown in FIG. 1.

It will be appreciated from the foregoing that it is vital, in a multi-zonal system, to provide procedures and means whereby tags associated with video material to be broadcast from any zone are notified to, and retained within, the broadcasting zone before any such video material is broadcast.

In principle, every tag associated with every piece of video material in any zone can be notified to all other zones as a matter of course, and stored therein. However, the long-term retention of such tags would be wasteful of local (zonally-based) storage, since all tags and all necessary associative material identifying the video material to which they apply would be retained in all zones, irrespective of whether or not individual zones contained any of the tagged video material.

In accordance with the invention, the problem is addressed by means of a network management system in which each zone periodically notifies new tags to all other zones by publishing over the network a list of tags, and the frame identities associated with such tags, as they are received. The remaining zone or zones are provided with management means configured to check their local storage for these frame identities and, if found, to retain the appropriate tags and associate them with the appropriate video information.

Any tags relating to video material not currently stored within a zone are not retained by the zone manager and are thus rejected. In this respect, it will be appreciated that, if that particular video material is later copied to that zone from another zone, any tags associated with that video material will be forwarded to the receiving zone as part of the copying protocol.

Referring now to the drawings, video material V new to the system and derived from any source (for example an archival store or a camera or a satellite or other communications link) is supplied to a first zone 1 and directed to suitable storage on a server 3 in that zone by a zone manager 4. The zone manager 4 is also configured to detect any tags associated with the video material V and to store them in such a way that any user calling up the video material V on any server in zone 1 is automatically appraised of the content of the tag or tags associated therewith.

The zone manager 4 is also configured to notify its receipt of tags to its counterparts in other zones by broadcasting the tags and the frame identities of the video material with which they are associated over the network to all other zones, such as zone 2, wherein a zone manager 5 receives the broadcast notification. Each zone manager is configured to compare the frame identities of the video material associated with all newly-notified tags with the frame identities of all video materials currently stored on all servers in the zone and thus, for example, the zone manager 5 is able to determine whether or not tags notified to it by zone manager 4 relate to video material currently stored on any server in zone 2. Zone manager 5 thus is configured to retain any tags relating to video material currently stored on any server in zone 2, and to reject all other tags.

If subsequently the same video material V is copied from zone 1 to a server in zone 2, the copying protocols are such that the zone manager 5 is supplied with all tags associated with the video material V, and thus the system is made substantially fail-safe.

In a preferred system, the tags are time-stamped in order to permit any conflicts in the content of multiple tags relating to the same video material to be resolved by making the most recent prevail.

It is further preferred that the system comprises means for periodically purging each zone of tags which apply to video information no longer stored in that zone. This can be implemented by means of a network-based background purger running at pre-selected intervals in communication with the zone managers such as 4 and 5. If this is done, the protocols implemented by the zone managers such as 4 and 5 can be changed such that all tags are stored in all zones as received; those tags not associated with the video information currently stored in any given zone being purged at the next operation of the background purger.

Instead of utilising zone managers such as 4 and 5 to oversee the retention and rejection of tags for entire zones, the invention may, if preferred, be implemented using individual server managers such that the respective manager for each server in each zone stores tags associated with video material stored only on that server. In this event, however, it is preferred that a zonal manager be provided to correlate the activities of the server managers in order to avoid unnecessary duplication of video materials and tags in each zone, and to ensure that purging is carried out correctly.

The information conveyed by the tags is typically configured only to provide advice to the system operators, and can be over-ridden by operators with suitable authority. In the normal course of operation, therefore, the tags are generally assistive of the overall process but not controlling or mandatory, though they can of course be made controlling or mandatory in appropriate circumstances.

1. A network-based video editing system in which video material, all frames of which bear unique identifiers, is made available on demand to servers located in a plurality of spatially separated zones linked via the network and wherein certain of the video material has associated therewith one or more signals or signs (hereinafter called “tags”), indicative of cautionary or advisory information; each zone of the system comprising:
(a) notification means for providing notifications to the other zone or zones of tags as they are received;
(b) management means for receiving such notifications from the other zone or zones, for deriving from such notifications one or more frame identifiers relating to the video material associated with notified tags, comparing the frame identifiers so derived with those relating to video material stored in the zone, retaining any said tag which relates to such stored video material, for associating respective retained tags with the appropriate stored video material, and for rejecting other tags; and
(c) further means for transmitting to any other zone all tags associated with video information copied to said other zone.

2. A system according to claim 1 wherein, the video information is time-stamped in order to permit any conflicts in the content of multiple tags relating to the same video material to be resolved by making the most recent prevail.

3. A system according to claim 1 or claim 2 further comprising means for periodically purging each zone of tags which apply to video information no longer stored in that zone.

4. A system according to claim 3 wherein the purging means comprises a background purger running at pre-selected intervals.

5. A system according to claim 4 wherein each said management means is effective to retain all tags as received and to reject those tags not associated with the video information in its respective zone in response to the next operation of the background purger for that zone.

6. A method of operating a network-based video editing system in which video material, all frames of which bear unique identifiers, is made available on demand to servers located in a plurality of spatially separated zones linked via the network and wherein certain of the video material has associated therewith one or more signals or signs (hereinafter called “tags”), indicative of cautionary or advisory information, wherein (a) new tags associated with material in any zone are broadcast generally to all other zones; (b) only tags associated with video information stored in any zone are retained in that zone and (c) all tags associated with information copied from a first zone to a second zone are supplied to the second zone.

7. A method according to claim 6 including the further step of time-stamping the video information and wherein any conflicts in the content of multiple tags relating to the same video material are resolved by making the most recent prevail.

8. A method according to claim 6 or claim 7 comprising the further step of periodically purging each zone of tags which apply to video information not stored in that zone.
